(19) United States
(12) Patent Application Publication
(10) Pub. No.: US 2018/0215123 A1
(43) Pub. Date: Aug. 2, 2018

(54) THERMALLY BONDED MULTI-LAYERED LAMINATE AND METHODS OF MAKING AND USING THE SAME

(71) Applicant: Precision Fabrics Group, Inc., Greensboro, NC (US)

(72) Inventors: James Flippin, Greensboro, NC (US); Mark Gillette, Burlington, NC (US)

(21) Appl. No.: 15/880,760

(22) Filed: Jan. 26, 2018

Related U.S. Application Data
(60) Provisional application No. 62/451,153, filed on Jan. 27, 2017.

(51) Int. Cl. B32B 5/02; B32B 3/26; B32B 37/18

(52) U.S. Cl. CPC B32B 5/022; B32B 3/263; B32B 37/18; B32B 2307/726; B32B 2262/067; B32B 2262/0253; B32B 2262/0276; B32B 2555/00

(57) ABSTRACT

A multi-layered laminate is described along with methods of making and/or using the same. Thus, in one aspect, a multi-layered laminate is provided comprising a first outer nonwoven fabric layer comprising thermoplastic fibers in an amount greater than 50% by weight of the first outer nonwoven fabric layer; a second outer nonwoven fabric layer comprising thermoplastic fibers in an amount greater than 50% by weight of the second outer nonwoven fabric layer; and an inner nonwoven fabric layer that is between the first and second outer nonwoven fabric layers. The laminate may be used in production of a multi-use towel, such as, e.g., a shop towel.

### STATEMENT OF PRIORITY

This application claims the benefit of U.S. Provisional Application No. 62/451,153, filed on Jan. 27, 2017, the disclosure of which is incorporated herein by reference in its entirety.

### FIELD

The present invention relates generally to laminated articles, such as towels, and to methods of making and/or using the same, including, for example, in durable applications such as shop towels.

### BACKGROUND

The health risks presented by the use of contaminated shop towels have been discussed at International Nonwovens & Disposables Association (INDA) meetings. Various products have been introduced to meet customer demand for towels free of hazardous contaminants. Until July 2013, when the Environmental Protection Agency (EPA) published its final solvent contaminated wipes rule (see, for example, the Missouri Dept. of Natural Resources website providing INDA comments on the EPA solvents wipes rule), disposable towels containing solvent and metals were treated as hazardous but laundered towels containing solvent and metals were exempt from such rules. Thus, laundered towels had a substantial cost advantage over disposable towels. However, since 2013 laundered shop towels have had to compete more directly with disposable towels. Consequently, for laundered and rented shop towels to be competitive with disposable towels, vendors must be able to achieve cleaner towels that last longer.

### SUMMARY OF EXAMPLE EMBODIMENTS

One aspect of the invention provides a multi-layered laminate comprising: a first outer nonwoven fabric layer comprising thermoplastic fibers in an amount greater than 50% by weight of the first outer nonwoven fabric layer; a second outer nonwoven fabric layer comprising thermoplastic fibers in an amount greater than 50% by weight of the second outer nonwoven fabric layer; and an inner nonwoven fabric layer that is between the first and second outer nonwoven fabric layers, wherein the multi-layered laminate does not comprise pores or comprises pores with an area of less than 0.03 square millimeters.

Another aspect provides a method of manufacturing a multi-layered laminate, the method comprising: thermally laminating together a first outer nonwoven fabric layer, a second outer nonwoven fabric layer, and an inner nonwoven fabric layer that is between the first and second outer nonwoven fabric layers, wherein the first outer nonwoven fabric layer comprises thermoplastic fibers in an amount greater than 50% by weight of the first outer nonwoven fabric layer and the second outer nonwoven fabric layer comprises thermoplastic fibers in an amount greater than 50% by weight of the second outer nonwoven fabric layer; and wherein the multi-layered laminate does not comprise pores or comprises pores with an area of less than 0.03 square mm.

The foregoing and other aspects of the present invention will now be described in more detail including other embodiments described herein.

### BRIEF DESCRIPTION OF THE DRAWINGS

FIG. 1 illustrates an exemplary multilayer laminate according to embodiments of the invention.

FIG. 2 illustrates an exemplary process for making a multi-layered laminate according to embodiments of the invention.

FIG. 3 illustrates an exemplary bonding pattern showing 18% bond area anvil roll specifications.

### DETAILED DESCRIPTION

The present invention now will be described hereinafter with reference to the accompanying drawings and examples, in which embodiments of the invention are shown. This description is not intended to be a detailed catalog of all the different ways in which the invention may be implemented, or all the features that may be added to the instant invention. For example, features illustrated with respect to one embodiment may be incorporated into other embodiments, and features illustrated with respect to a particular embodiment may be deleted from that embodiment. Thus, the invention contemplates that in some embodiments of the invention, any feature or combination of features set forth herein can be excluded or omitted. In addition, numerous variations and additions to the various embodiments suggested herein will be apparent to those skilled in the art in light of the instant disclosure, which do not depart from the instant invention. Hence, the following descriptions are intended to illustrate some particular embodiments of the invention, and not to exhaustively specify all permutations, combinations and variations thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. In case of a conflict in terminology, the present specification is controlling.

All publications, patent applications, patents and other references cited herein are incorporated by reference in their entireties for the teachings relevant to the sentence and/or paragraph in which the reference is presented.

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a composition comprises components A, B and C, it is specifically intended that any of A, B or C, or a combination thereof, can be omitted and disclaimed singularly or in any combination.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

The term “about,” as used herein when referring to a measurable value such as a dosage or time period and the like refers to variations of ±20%, ±10%, ±5%, ±1%, ±0.5%, or even ±0.1% of the specified amount.

As used herein, phrases such as “between X and Y” and “between about X and Y” should be interpreted to include X and Y. As used herein, phrases such as “between about X and Y” mean “between about X and about Y” and phrases such as “from about X to Y” mean “from about X to about Y.”

The term “comprise,” “comprises” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the recited materials or steps recited in the claim and those that do not materially affect the basic and novel characteristic(s) of the claimed invention. Thus, the term “consisting essentially of” should not be interpreted to be equivalent to “comprising.”

As used herein, the term “increase” (and grammatical variations thereof) describe an elevation in the specific parameter of at least about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300%, 400%, 500% or more as compared to a control.

As used herein, the terms “reduce,” “diminish,” and “decrease” (and grammatical variations thereof), describe, for example, a decrease of at least about 5%, 10%, 15%, 20%, 25%, 35%, 50%, 75%, 80%, 85%, 90%, 95%, 97%, 98%, 99%, or 100% as compared to a control.

Like numbers refer to like elements throughout. In the figures, the thickness of certain lines, layers, components, elements or features may be exaggerated for clarity. The abbreviations “FIG. and “Fig.” for the word “Figure” can be used interchangeably in the text and figures.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s). It will be understood that the spatially relative terms are intended to encompass different orientations of an element or laminate in use or operation in addition to the orientation depicted in the figures. For example, if the laminate in the figures is inverted, elements described as “under” or “beneath” other elements or features would then be oriented “over” the other elements or features. Thus, the exemplary term “under” can encompass both an orientation of “over” and “under.” The laminate may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

Embodiments of the present invention are directed to a multi-layered laminate along with methods of making and using the same. A multi-layered laminate of the present invention may comprise at least two layers (e.g., 2, 3, 4, 56, 7, 8, 9, 10, or more layers) of a nonwoven fabric. In some embodiments, a multi-layered laminate of the present invention may comprise at least three layers (e.g., 3, 4, 5, 6, 7, 8, 9, 10, or more layers) of a nonwoven fabric).

A multi-layered laminate may comprise a first outer nonwoven fabric layer comprising, consisting essentially of, or consisting of thermoplastic fibers in an amount greater than 50% by weight (e.g., greater than 50, 55, 60, 65, 70, 75, 80, 85, 90, 95, 100% by weight or any range or value therein) of the first outer nonwoven fabric layer. In some embodiments, a multi-layered laminate may comprise a second outer nonwoven fabric layer comprising, consisting essentially of, or consisting of thermoplastic fibers in an amount greater than 50% by weight (e.g., greater than 50, 55, 60, 65, 70, 75, 80, 85, 90, 95, 100% by weight or any range or value therein) of the second outer nonwoven fabric layer. An inner nonwoven fabric layer may be between the first and second outer nonwoven fabric layers. In some embodiments, the inner layer of a multi-layered laminate may comprise, consist essentially of, or consist of thermoplastic fibers in an amount greater than 50% by weight (e.g., greater than 50, 55, 60, 65, 70, 75, 80, 85, 90, 95, 100% by weight or any range or value therein) of the inner nonwoven fabric layer. Thus, in some embodiments, a multi-layered laminate is provided, the multi-layered laminate comprising: a first outer nonwoven fabric layer comprising thermoplastic fibers in an amount greater than 50% by weight of the first outer nonwoven fabric layer; a second outer nonwoven fabric layer comprising thermoplastic fibers in an amount greater than 50% by weight of the second outer nonwoven fabric layer; and an inner nonwoven fabric layer that is between the first and second outer nonwoven fabric layers and comprising thermoplastic fibers in an amount greater than 50% by weight of the inner nonwoven fabric layer.

A multi-layered laminate of the present invention does not comprise pores or may comprise pores having an area of less than 0.03 square millimeters (e.g., less than 0.03, 0.029, 0.028, 0.027, 0.026, 0.025, 0.024, 0.023, 0.022, 0.021, 0.02, 0.019, 0.018, 0.017, 0.016, 0.015, 0.014, 0.013, 0.012, 0.011, 0.01, 0.009, 0.008, 0.007, 0.006, 0.005, 0.004, 0.003, 0.002, 0.0001 square millimeters, or any range or value therein). Thus, in some embodiments the pore size of a multilayered laminate of the invention may comprise, consist essentially of, or consist of an area of less than 0.03 square millimeters.

The first and second outer nonwoven fabric layers and/or the inner fabric layer may each comprise any suitable thermoplastic fibers having a melting point above 220° F., a thermal shrinkage of less than 5% at 220° F., and which may be thermally bonded. Example thermoplastic fibers for the first outer nonwoven fabric layer, the second outer nonwoven fabric layer and/or the inner fabric layer include, but are not limited to, polypropylene fibers, polyester fibers, polyethylene terephthalate fibers, polylactic acid fibers, polyolefin fibers, and/or blends thereof. In some embodiments, the first outer nonwoven fabric layer, the second outer nonwoven fabric layer and/or the inner fabric layer of the multi-layered laminate may comprise a blend of thermoplastic fibers and absorbent fibers with the thermoplastic fibers being present in an amount greater than 50% by weight.

In some embodiments, the thermoplastic fibers of the first outer nonwoven fabric layer and/or the second outer nonwoven fabric layer may comprise a sheath-core fiber, such as e.g., a fiber with a polypropylene (PP) sheath and a polyester (PET) core. In some embodiments, a ratio of PP to PET in a sheath-core fiber may be about 50% PP to 50% PET. In some embodiments, a ratio of PP to PET in a sheath-core fiber may be about 75% PP to 25% PET. In some embodiments, a ratio of PP to PET in a sheath-core fiber may be about 25% PP to 75% PET.

In some embodiments, the first outer nonwoven fabric layer may comprise absorbent fibers (e.g., non-thermoplastic fibers) in an amount of less than 50% by weight (e.g., less than 50, 45, 40, 35, 30, 25, 20, 15, 10, 5, 0%, or any range or value therein) of the first outer nonwoven fabric layer and/or the second outer nonwoven fabric layer may comprise absorbent fibers (e.g., non-thermoplastic fibers) in an amount of less than 50% by weight (e.g., less than 50, 45, 40, 35, 30, 25, 20, 15, 10, 5, 0%, or any range or value therein) of the second outer nonwoven fabric layer. In some embodiments, the absorbent fibers may be any cellulosic fiber that may be cleaned in a laundry process, such as for example rayon, viscose, viscose rayon, tencel, cupro, modal, lyocel, cotton, and/or woodpulp. In some embodiments a cellulosic fiber includes, but is not limited to, rayon, viscose, viscose rayon, tencel, cupro, modal and/or lyocell.

In some embodiments, the first outer nonwoven fabric layer and/or the second outer nonwoven fabric layer may comprise, consist essentially of, or consist of a blend of absorbent fibers and polypropylene (PP)/polyester (PET) fibers. In some embodiments, the first outer nonwoven fabric layer and/or the second outer nonwoven fabric layer of the multi-layered laminate may comprise a spunlaced blend of absorbent fibers (e.g., rayon fibers) and sheath-core polypropylene (PP)/polyester (PET) fibers. In some embodiments, the first outer nonwoven fabric layer and/or the second outer nonwoven fabric layer may comprise absorbent fibers in an amount of about 5% to about 40% (e.g., about 5, 10, 15, 20, 25, 30, 35, 40%, or any range or value therein), optionally about 20% to about 35% (e.g., about 20, 21, 22, 23, 24, 25, 26, 27, 28, 29, 30, 31, 32, 33, 34, 35%, or any range or value therein), and sheath-core PP/PET fibers in an amount of about 60% to about 95% (e.g., about 60, 65, 70, 75, 80, 85, 90, 95%, or any range or value therein), optionally about 60% to about 80% (e.g., about 60, 61, 62, 63, 64, 65, 66, 67, 68, 69, 70, 71, 72, 73, 74, 75, 76, 77, 78, 79, 80%, or any range or value therein). In some embodiments, the first outer nonwoven fabric layer and/or the second outer nonwoven fabric layer of a multi-layered laminate of the invention may comprise at least about 70% sheath-core PP/PET fibers (e.g., at least about 70, 75, 80, 85, 90, 95, 100%, and the like, or any range or value therein), and about 30% or less absorbent fibers (e.g., less than about 30, 25, 20, 15, 10, 5, 0%, and the like, or any value or range therein). In some embodiments, the ratio of PP to PET in the first outer nonwoven fabric layer and/or the second outer nonwoven fabric layer of a multi-layered laminate can be about 50%/50%. In some embodiments, the absorbent fibers comprise, consist essentially of, or consist of rayon fibers.

In some embodiments, the thermoplastic fibers of the first outer nonwoven fabric layer and/or of the second outer nonwoven fabric layer may have a melting point above 220° F. (e.g., above 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375° F., and the like, or any range or value therein). In some embodiments, the thermoplastic fibers of the first outer nonwoven fabric layer and/or of the second outer nonwoven fabric layer may have a thermal shrinkage of less than about 5% at 220° F. (e.g., less than about 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1. 0.9, 0.8, 0.7, 0.5% thermal shrinkage and the like, or any range or value therein).

In some embodiments, the thermoplastic fibers of the first outer nonwoven fabric layer and/or of the second outer nonwoven fabric layer may be thermally bonded to another layer (e.g., a nonwoven layer comprising thermoplastic fibers in an amount of greater than 50% by weight).

In some embodiments, the outer nonwoven fabric layer and/or the second outer nonwoven fabric layer may have a thermal shrinkage of less than 5% when heated to 325° F. for five minutes.

In some embodiments, the thermoplastic fibers of the first outer nonwoven fabric layer and/or the second outer nonwoven fabric layer may have a length of about 0.5 to about 3 inches (e.g., about 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3 inches, or any range or value therein). In some embodiments, the thermoplastic fibers of the first outer nonwoven fabric layer and/or the second outer nonwoven fabric layer may have a denier of about 0.6 to about 5 (e.g., a denier of about 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, or any range or value therein). In some embodiments, the absorbent fibers of the first outer nonwoven fabric layer and/or the second outer nonwoven fabric layer may comprise a length of about 0.5 to about 2.5 inches (e.g., about 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5 or any range or value therein). In some embodiments, the absorbent fibers of the first outer nonwoven fabric layer and/or the second outer nonwoven fabric layer may comprise a denier of about 0.8 to about 4 (e.g., a denier of about 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, or any range or value therein).

In some embodiments, an inner nonwoven fabric layer of a multi-layered laminate of the invention may comprise thermoplastic fibers. Exemplary thermoplastic fibers of the inner nonwoven fabric layer include but are not limited to polypropylene fibers, polyester fibers, polyethylene terephthalate fibers, polylactic acid fibers, polyolefin fibers, sheath-core fibers (e.g., a fiber with a polypropylene (PP) sheath and a polyester (PET) core, for example as described herein), and/or blends thereof. In some embodiments, the inner nonwoven layer may comprise spunbond polypropylene fibers. In some embodiments, the thermoplastic fibers of the inner nonwoven fabric layer may be present in an amount of greater than 50% by weight (e.g., 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 95, 96, 97, 98, 99, 100% by weight, or any range or value therein). In some embodiments, the inner nonwoven fabric layer comprises thermoplastic fibers in an amount less than 100% (e.g., about 96%, 95%, 94%, 93%, 92%, 91%, 90% or less) by weight of the inner nonwoven fabric layer. In some embodiments, the inner nonwoven fabric layer does not comprise thermoplastic fibers in an amount of 100% by weight of the inner nonwoven fabric layer. Thus, in some embodiments, the inner nonwoven fabric layer may comprise an amount of thermoplastic fibers in a range of about 51% to about 100%, about 55% to about 100%, about 60% to about 100%, about 70% to about 100%, about 80% to about 100%, about 51% to about 95%, about 55% to about 95%, about 60% to about 95%, about 70% to about 95%, about 80% to about 95%, about 51% to about 90%, about 55% to about 90%, about 60% to about 90%, about 70% to about 90%, about 80% to about 90%, about 51% to about 85%, about 55% to about 85%, about 60% to about 85%, about 70% to about 85%, about 80% to about 85%, about 51% to about 80%, about 55% to about 80%, about 60% to about 80%, about 70% to about 80%, about 51% to about 75%, about 55% to about 75%, about 60% to about 75% by weight of the inner nonwoven fabric layer.

In some embodiments, the thermoplastic fibers of the inner nonwoven fabric layer may be continuous (e.g., extruded).

In some embodiments, the thermoplastic fibers of the inner nonwoven fabric layer may comprise a sheath-core fiber, such as e.g., a fiber with a polypropylene (PP) sheath and a polyester (PET) core. In some embodiments, a ratio of PP to PET in a sheath-core fiber may be about 50% PP to 50% PET. In some embodiments, a ratio of PP to PET in a sheath-core fiber may be about 75% PP to 25% PET. In some embodiments, a ratio of PP to PET in a sheath-core fiber may be about 25% PP to 75% PET.

In some embodiments, the inner nonwoven fabric layer may comprise absorbent fibers (e.g., non-thermoplastic fibers) in an amount of less than 50% by weight (e.g., less than 50, 45, 40, 35, 30, 25, 20, 15, 10, 5, 0%, or any range or value therein) of the inner nonwoven fabric layer. In some embodiments, the absorbent fibers may be any cellulosic fiber that may be cleaned in a laundry process, such as for example rayon, viscose, viscose rayon, tencel, cupro, modal, lyocel, cotton, and/or woodpulp. In some embodiments a cellulosic fiber may include, but is not limited to, rayon, viscose, viscose rayon, tencel, cupro, modal and/or lyocell.

In some embodiments, the inner nonwoven fabric layer may comprise, consist essentially of, or consist of a blend of absorbent fibers and polypropylene (PP)/polyester (PET) fibers. In some embodiments, the inner nonwoven fabric layer of the multi-layered laminate may comprise a spunlaced blend of absorbent fibers (e.g., rayon fibers) and sheath-core polypropylene (PP)/polyester (PET) fibers. In some embodiments, the inner nonwoven fabric layer may comprise absorbent fibers in an amount of about 5% to about 40% (e.g., about 5, 10, 15, 20, 25, 30, 35, 40%, or any range or value therein), optionally about 20% to about 35% (e.g., about 20, 21, 22, 23, 24, 25, 26, 27, 28, 29, 30, 31, 32, 33, 34, 35%, or any range or value therein), and sheath-core PP/PET fibers in an amount of about 60% to about 95% (e.g., about 60, 65, 70, 75, 80, 85, 90, 95%, or any range or value therein), optionally about 60% to about 80% (e.g., about 60, 61, 62, 63, 64, 65, 66, 67, 68, 69, 70, 71, 72, 73, 74, 75, 76, 77, 78, 79, 80%, or any range or value therein). In some embodiments, the inner nonwoven fabric layer of a multi-layered laminate of the invention may comprise at least about 70% sheath-core PP/PET fibers (e.g., at least about 70, 75, 80, 85, 90, 95, 100%, and the like, or any range or value therein), and about 30% or less absorbent fibers (e.g., less than about 30, 25, 20, 15, 10, 5, 0%, and the like, or any value or range therein). In some embodiments, the ratio of PP to PET in the inner nonwoven fabric layer of a multi-layered laminate can be about 50%/50%. In some embodiments, the absorbent fibers comprise, consist essentially of, or consist of rayon fibers.

In some embodiments, the thermoplastic fibers of the inner nonwoven fabric layer may have a melting point above 220° F. (e.g., above 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375° F., and the like, or any range or value therein). In some embodiments, the thermoplastic fibers of the inner nonwoven fabric layer may have a thermal shrinkage less than about 5% at 220° F. (e.g., less than about 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5% thermal shrinkage, and the like, or any range or value therein).

In some embodiments, the thermoplastic fibers of the inner nonwoven fabric layer may be thermally bonded to another layer (e.g., a nonwoven layer that comprises greater than 50% thermoplastic fibers).

In some embodiments, the inner nonwoven fabric layer may have a thermal shrinkage of less than 5% when heated to 325° F. for five minutes.

In some embodiments, the thermoplastic fibers of the inner nonwoven fabric layer may have a length of about 0.5 to about 3 inches (e.g., about 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3 inches, or any range or value therein). In some embodiments, the thermoplastic fibers of the inner nonwoven fabric layer may have a denier of about 0.6 to about 3 or 5 (e.g., a denier of about 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, or any range or value therein). In some embodiments, the absorbent fibers of the inner nonwoven fabric layer may comprise a length of about 0.5 to about 2.5 inches (e.g., about 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5 or any range or value therein). In some embodiments, the absorbent fibers of the inner nonwoven fabric layer may comprise a denier of about 0.8 to about 4 (e.g., a denier of about 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, or any range or value therein).

A laminate of the present invention may have any suitable basis weight. In some embodiments, the first and/or second outer nonwoven fabric layers of the multi-layered laminate may have a basis weight in a range of about 15 grams per square meter (gsm) to about 70 gsm (e.g., about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70 gsm, or any range or value therein). In some embodiments, the first and/or second outer nonwoven fabric layers may have a basis weight in a range of about 45 gsm to about 55 gsm (e.g., about 45, 46, 47, 48, 49, 50, 51, 52, 53, 54, 55 gsm, or any range or value therein). In some embodiments, the inner nonwoven fabric layer of the multi-layered laminate may have a basis weight in a range of about 15 gsm to about 70 gsm (e.g., about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70 gsm, or any range or value therein).

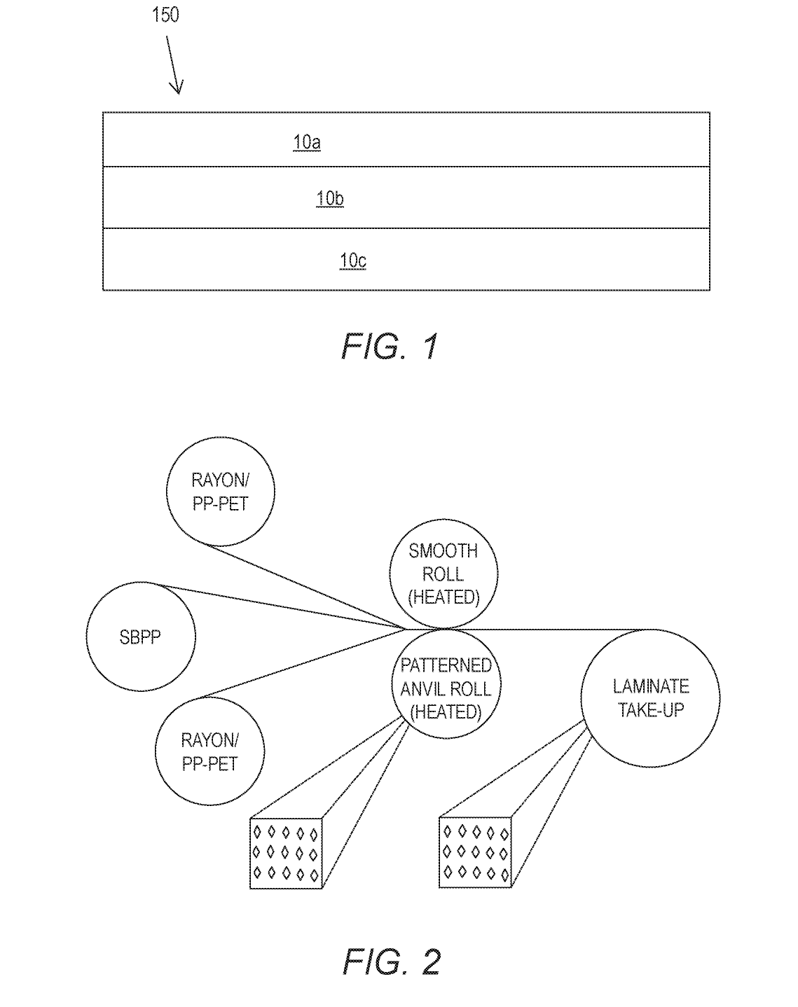

Referring to FIG. 1, in some embodiments, a multilayered laminate 150 may comprise a first outer nonwoven layer 10a, a second outer nonwoven layer 10c, and an inner nonwoven layer 10b. In some embodiments, one outer nonwoven layer, 10a or 10c, may be absent. In some embodiments, a multilayered laminate may comprise more than three layers. For example, a first inner nonwoven layer 10b may be between a first and a second outer nonwoven layer 10a, 10c, and a second inner nonwoven layer may be between the first outer nonwoven layer 10a and a third outer nonwoven layer and the like, resulting in a laminate comprising five layers and so on. In some embodiments, the outer nonwoven layers of a multi-layered laminate of the present invention (e.g., nonwoven layers comprising thermoplastic fibers in an amount greater than 50% by weight; e.g., a first and a second outer nonwoven layer) may be identical to one another or they may be substantially similar to one another. In some embodiments, the inner nonwoven layer(s) of a multi-layered laminate of the present invention may be identical to the first outer nonwoven layer and/or the second outer nonwoven layer. In some embodiments, the inner nonwoven layer(s) of a multi-layered laminate of the present invention may be substantially similar the first outer nonwoven layer and/or the second outer nonwoven layer. “Substantially similar,” as used herein, means about 70% to about 99%, about 80 to about 99%, about 85% to about 99%, about 90% to about 99%, about 95% to about 99%, (e.g., about 70, 71, 72, 73, 74, 75, 76, 77, 78, 79, 80, 81, 82, 83, 84, 85, 86, 87, 88, 89, 90, 91, 92, 93, 94, 95, 96, 97, 98, 99% and any range or value therein) similar in composition and characteristics. In some embodiments, the layers of a multilayer laminate of the present invention may be thermally bonded to each other.

In some embodiments, a multilayered laminate may comprise three layers, wherein the first outer nonwoven fabric layer, the second outer nonwoven fabric layer, and the inner nonwoven fabric layer may be thermally bonded together. The thermal lamination process may comprise, for example, heated, patterned anvil rolls pressing the fabrics together on a heated smooth roll (FIG. 2). Thus, when there are two outer layers and an inner layer, the heat and pressure thermally bonds the sheath of the fibers of the outer layers with the polypropylene of the inner layer. Exemplary thermal bonding process conditions may include: line speed of about 100 feet per minute, anvil and pattern roll temperatures of about 325 F with a nip pressure of about 525 pounds per linear inch.

In some embodiments, a multi-layered laminate of the present invention comprises about 20 to about 60 bond points per square inch (e.g., about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 bond points, or any range or value therein). In some embodiments, a multi-layered laminate of the present invention comprises about 25 to about 39 bond points per square inch. In some embodiments, a multi-layered laminate of the present invention comprises about 32 bond points per square inch.

In some embodiments, a multi-layered laminate of the present invention comprises a bonded area in a range of about 8% to about 25% (e.g., about 8, 9, 10, 11, 12, 13, 14, 15, 16, 17, 18, 19, 20, 21, 22, 23, 24, 25% or any range or value therein). In some embodiments, the bonded area is from about 10 to about 25%, about 15 to about 25%, about 10% to about 20%, about 15% to about 20%, and the like. In some embodiments, the multi-layered laminate may comprise, consist essentially of, or consist of a bonded area in a range of about 10% to about 20% (e.g., about 10, 11, 12, 13, 14, 15, 16, 17, 18, 19, 20%, or any range or value therein).

In some embodiments, a multi-layered laminate of the present invention may have a thermal shrinkage of less than 5% (e.g., less than about 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5%, or any range or value therein) when heated to 325° F. for five minutes.

In some embodiments, a multi-layered laminate of the present invention may have a grab tensile strength in the machine direction (MD) in a range of about 25 lbs to about 60 lbs (e.g., about 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 lbs, or any range or value therein) as determined in accordance with ASTM D5034. In some embodiments, the multi-layered laminate may have a grab tensile strength in the machine direction (MD) in a range of about 40 lbs to about 50 lbs (e.g., about 40, 41, 42, 43, 44, 45, 46, 47, 48, 49, 50 lbs, or any range or value therein) in accordance with ASTM D5034.

In some embodiments, a multi-layered laminate of the present invention may have a grab tensile strength in the cross-machine direction (XD) of about 15 lbs to about 60 lbs (e.g., about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 lbs, or any range or value therein) as determined in accordance with ASTM D5034. In some embodiments, the multi-layered laminate may have a grab tensile strength in the cross-machine direction (XD) of about 30 lbs to about 40 lbs (e.g., about 30, 31, 32, 33, 34, 35, 36, 37, 38, 39, 40 lbs, or any range or value therein) in accordance with ASTM D5034.

A laminate of the present invention may have a bond strength of about 20 grams per inch or more. The bond strength may be measured between adjacent layers of the laminate and/or may be measured in accordance with AATCC 136. In some embodiments, bond strength may be measured in machine direction (MD) and/or cross machine direction (XD). The bond strength between one or more adjacent layers of a laminate of the present invention may be such that the layers do not delaminate during cutting, sewing, and/or other operations such as laundering. In some embodiments, the multi-layered laminate may have a laminated bond strength in the machine direction (MD) and/or cross direction (XD) in a range of about 20 grams/inch to about 500 grams/inch (e.g., about 20, 30, 40, 50, 60, 70, 80, 90, 100, 125, 150, 175, 200, 225, 250, 275, 300, 325, 350, 375, 400, 425, 450, 475, 500 grams/inch, or any range or value therein) as determined in accordance with AATCC 136. In some embodiments, the multi-layered laminate may have a laminated bond strength in the machine direction (MD) and/or cross direction (XD) in a range of about 100 grams/inch to about 300 grams/inch (e.g., about 100, 110, 120, 130, 140, 150, 160, 170, 180, 190, 200, 210, 220, 230, 240, 250, 260, 270, 280, 290, 300 grams/inch, or any range or value therein) in accordance with AATCC 136.

According to some embodiments, a laminate of the present invention may comprise at least two nonwoven fabric layers that are laminated together (e.g., thermally bonded) and may have a bond strength at each adjacent fabric layer that is at least about 20, 30, 40, 50, 60, 70, 80, 90, 100, 150, 200, 250, 300, 350, 400, 450, 500 grams/inch or more. The bond strength may be measured between each adjacent fabric layer and/or may be measured in accordance with AATCC 136.

In some embodiments, a multi-layered laminate of the present invention may have a Mullen Burst strength of at least about 20 psi (e.g., at least about 20, 25, 30, 35, 40, 45, 50, 55, 60, 65, 70, 75, 80, 85, 90, 95, 100, 105, 110, 115, 120, 125, 130, 135, 140, 145, 150 psi or more, or any range or value therein) as measured in accordance with INDA 30.0-70. In some embodiments, the multi-layered laminate may have a Mullen Burst strength in the range of about 20 psi to about 120 psi (e.g., about 20, 25, 30, 35, 40, 45, 50, 55, 60, 65, 70, 75, 80, 85, 90, 95, 100, 105, 110, 115, 120 psi, or any range or value therein) as measured in accordance with INDA 30.0-70.

In some embodiments, a multi-layered laminate of the present invention may have a Handle-O-Meter value in the MD in a range of about 90 grams/inch to about 160 grams/inch (e.g., about 90, 91, 92, 93, 94, 95, 96, 97, 98, 99, 100, 101, 102, 102, 104, 105, 106, 107, 108, 109, 110, 115, 120, 125, 130, 135, 140, 145, 150, 155, 160 grams/inch, or any range or value therein) as determined as measured in accordance with INDA 90.0-75 with a 20 mm gap on instrument and a 4 inch (width) by 7 inch (length) sample of the laminate. In some embodiments, the multi-layered laminate may have a Handle-O-Meter value in the MD in a range of about 110 grams to about 140 grams/inch (e.g., about 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140 grams/inch, or any range or value therein) as measured in accordance with INDA 90.0-75 with a 20 mm gap on instrument and a 4 inch (width) by 7 inch (length) sample of the laminate.

In some embodiments, a multi-layered laminate of the present invention has a Handle-O-Meter value in the XD in a range of about 20 grams/inch to about 80 grams/inch (e.g., about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80 grams/inch, or any range or value therein) as measured in accordance with INDA 90.0-75 with 20 mm gap on instrument and a 4 inch (width) by 7 inch (length) sample of the laminate. In some embodiments, the multi-layered laminate has a Handle-O-Meter value in the XD in a range of about 35 grams/inch to about 65 grams/inch (e.g., about 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65 grams, or any range or value therein) as measured in accordance with INDA 90.0-75 with 20 mm gap on instrument and a 4 inch (width) by 7 inch (length) sample of the laminate.

In some embodiments, a multi-layered laminate of the present invention may have an Elmendorf tear strength in the MD and/or in the XD of at least about 2000 grams (e.g., about 2000, 2100, 2200, 2300, 2400, 2500, 2600, 2700, 2800, 2900, 3000, 3100, 3200, 3300, 3400, 3500, 3600, 3700, 3800, 3900, 4000 grams or more, or any range or value therein). In some embodiments, the multi-layered laminate may have an Elmendorf tear strength in the MD and/or in the XD in the range of about 1000 grams to about 3000 grams (e.g., about 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000 grams, and the like or any range or value therein).

In some embodiments, a multi-layered laminate of the present invention may have a fluid (e.g., an aqueous fluid) absorbance capacity of at least about 500% (e.g., at least 500, 550, 600, 650, 700, 750, 800, 850, 900% and the like) as measured in accordance with INDA 10.1.

A multi-layered laminate of the present invention may comprise advantageous characteristics over a standard cotton fabric including, but not limited to, increased durability, lifetime, and/or resistance to shrinkage and/or a reduced drying time compared to, for example, a woven cotton fabric. In some embodiments, durability can mean durability through multiple (e.g., at least 8, at least 25, or more) washing and drying cycles. In some embodiments, increased durability of a multi-layered laminate of the present invention can mean reduced linting, no delamination and/or no holes through the entirety of the fabric as compared to, for example, a woven 100% cotton fabric undergoing the same conditions (e.g., laundering conditions).

In some embodiments, a multi-layered laminate of the present invention may have a shrinkage that is at least 5% to about 30% (e.g., at least 6, 7, 8, 9, 10, 11, 12, 13, 14, 15, 16, 17, 18, 19, 20, 21, 22, 23, 24, 25, 26, 27, 28, 29, 30% or more) less than the shrinkage of a commercial woven cotton fabric (e.g., a 100% woven cotton fabric). In some embodiments, a multi-layered laminate of the present invention may have a shrinkage that is at least 5% less than the shrinkage of a commercial woven cotton fabric (e.g., a 100% woven cotton fabric).

In some embodiments, a multi-layered laminate of the present invention may have a shrinkage that is at least 10% less than the shrinkage of a commercial woven cotton fabric (e.g., a 100% woven cotton fabric). In some embodiments, the thermal shrinkage can result from laundering. In some embodiments, a multi-layered laminate of the present invention may have a shrinkage that is at least 5% to about 30% or less than the shrinkage of a commercial woven cotton fabric (e.g., a 100% woven cotton fabric) when laundered under the same or similar conditions.

In some embodiments, a multi-layered laminate of the present invention and/or an article when produced from the laminate may be more easily cleaned and dried than an article produced from standard cotton fabric (e.g., a woven cotton fabric). For example, after laundering, the multi-layered laminate may retain less than about 40% (e.g., less than about 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10% and the like, or any range or value therein) of soil (e.g., field and/or laboratory soil) present in the multi-layered laminate prior to laundering. In some embodiments, the multi-layered laminate may retain less than 25% of the soil present in the multi-layered laminate prior to laundering. In some embodiments, the laminate of the present invention may release at least 60% (e.g., at least 60, 65, 70, 75, 80, 85, 90, 95, 96, 97, 98, 99%, and the like) of the soil present in the fabric prior to laundering. In some embodiments, when laundered, the laminate of the present invention may release about 98% of the soil present in the fabric prior to laundering. A laundering process may be a residential and/or a commercial laundering process using residential and/or commercial laundering equipment.

In some embodiments, field and/or laboratory soil may comprise dirt (e.g., mud, feces), grease (e.g., lard, vegetable shortening, lubricants (e.g., engine grease) and the like), oil (e.g., motor oil, used motor oil, cooking oil, mineral oil, and the like), liquids (e.g., brake fluid, coolant, water, solvents, acetone, antifreeze, alcohol, kerosene, turpentine, methyl ethyl ketone (MEK), wine, coffee, blood, urine, juice, milk, and the like), paint, brake dust, carbon, metal shavings, wood shavings, and the like. In some embodiments laboratory soil may have a known composition, while field soil may be of an unknown or less well defined composition.

In some embodiments, a multi-layered laminate of the present invention may provide increased durability by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more compared to the durability of a current commercially available woven cotton fabric (e.g., a woven cotton towel, a woven cotton shop towel).

In some embodiments, the multi-layered laminate may remain intact (e.g., no delamination, holes through the fabric, and/or linting and/or fraying) after about 8 or more washes (e.g., 8, 9, 10, 11, 12, 13, 14, 15, 16, 17, 18, 19, 20, 21, 22, 23, 24, 25 or more and the like, or any range or value therein) with 8 or more dryings (e.g., 8, 9, 10, 11, 12, 13, 14, 15, 16, 17, 18, 19, 20, 21, 22, 23, 24, 25 or more and the like, or any range or value therein). In some embodiments, the multi-layered laminate may remain intact (e.g., no delamination, holes through the fabric, and/or linting and/or fraying) for about 10 washes and 10 dryings. In some embodiments, the multi-layered laminate may remain intact (e.g., no delamination, holes through the fabric, and/or linting and/or fraying) for about 25 washes and 25 dryings.

The washing and drying may be in a commercial or a residential washer and dryer.

Exemplary residential washing conditions can include, but are not limited to, a rotation of about 575 rpm to 700 rpm, a temperature of about 105° F. to 120° F. and wash time of about 30 min to 1 hour (e.g., 50 min) (e.g., Kenmore Model 2022). Exemplary residential drying conditions can include, but are not limited to, about 150° F. to 200° F. for about 10-25 minutes (about 30 towels per load).

Exemplary commercial washing conditions can include, but are not limited to, a rotation of about 542 rpm to 685 rpm, a temperature of about 165° F. to 185° F. and wash time of about 45 min to 1.5 hour (e.g., 60 min) (e.g., Milnor Washer/Extractor Model 30015VRJ). Exemplary commercial drying conditions can include, but are not limited to, about 400° F. to 500° F. for about 15-30 minutes (about 2000-3000 towels per load).

In some embodiments, the amount of linting in a multi-layered laminate of the invention after 8 or more washings and dryings can be about zero to about 1% of the original weight of the multi-layered laminate. In some embodiments, the amount of linting in a multi-layered laminate of the invention after 8 or more washings and dryings can be less than 1% of the original weight of the multi-layered laminate. In some embodiments, the amount of delamination (unbonding) of bonded layers of the multi-layered laminate after 8 or more washings and dryings is zero.

In some embodiments, delamination may be identified by the observation of unbonded layers and linting may be measured as a loss of weight from the multi-layered laminate as well as the weight of the material on the dryer lint filter.

A multilayer laminate of the present invention may be used for any purpose in which a durable, absorbent, and/or quick drying fabric is needed. For example, in some embodiments, the multi-layered laminate may be a towel, such as, for example, a shop towel or a bar towel. In some embodiments, a shop towel may be defined as a small piece of textile for wiping grease, oil and dirt or cleaning industrial equipment or similar purposes. Such towels may be used by a variety of industries including printing, auto-repair, equipment maintenance, restaurant, hotel, etc. Further uses of a multilayer laminate of the present invention may include, but are not limited to, a precursor fabric for another product, coating substrate (e.g., artificial leather), drop cloth, and/or protective cloth.

In some embodiments, a multi-layered laminate and/or article produced therefrom (e.g., towel, shop towel) may retain one or more positive aspects of a woven 100% cotton fabric and/or article produced therefrom (e.g., towel, shop towel), but may eliminate one or more negative aspects of the same.

For example, positive characteristics may include one or more of the following:
Drapeable hand of a towel;
Absorbent rate of a towel toward oil;
Absorbent capacity of a towel toward oil;
Consistent color (e.g., red) of a towel achieved using direct dyes used in the final step of the laundry process; and/or
Low manufacturing cost.

Negative aspects of a standard 100% cotton woven towel include:
Motor oil penetrates into the lumen of the fibers used to make the woven towel and this is difficult to remove by laundering;
A woven towel develops holes after repeated use and must be discarded;
Once a woven towel begins to fray along the edges, it must be discarded;
A woven towel has a regular pattern of large pores where the weft and warp fibers cross each other at right angles and these large pores trap and hold on to particles (e.g., metal particles) even retaining the particles through the laundering process; and/or
A long drying time.

In some embodiments, a multi-layered laminate may have one or more of the following features:
Durable to laundering (e.g., withstand at least eight commercial laundering and drying cycles without developing holes or fraying);
Does not melt or deform when dried in commercial drying equipment;
Made of fibers that allow removal of soil from the laminate during laundering;
Releases metal shavings during the laundering process;
Has a high rate of oil absorption and a high oil holding capacity when being used as a towel;
Has a moderate roughness so that the aesthetics are pleasing but also rough enough so that dirt can penetrate into the towel during use;
Has a drapeable hand;
Manufactured using high throughput economical processes that are commonly used in the nonwovens industry;
Has some water absorbency;
Uses fibers where minimum amounts of motor oil penetrate into the fiber;
Uses a high percentage of thermoplastic fibers;
Uses multiple layers of fabrics to create a thick laminate;
Uses multiple layers of fabric to close up pores in the laminate that may be more evident in a single layer fabric;
Uses commonly available fibers and/or fabrics that are relatively economical so that the resulting composite will be affordable;
Uses a bond pattern that is sufficient to bond the outer fabric layers to the inner fabric layer without creating excessive stiffness;
Uses a bond pattern and/or thermoplastic fibers of a specified length so that the bond points have enough intersection with fibers to create a durable structure;
Uses fibers that are not susceptible to chemical attack so that the towel will remain durable through the laundering process;
Uses fibers that have a melting point above 220° F. so that they do not melt flow through repeated drying processes;
Uses fibers with low thermal shrinkage to reduce differential shrinkage that may cause the laminate to tear apart during repeated drying processes; and/or
Color incorporated into some fibers so that the towel needs less over dyeing between uses.

In some aspects, the second nonwoven fabric layer of a multilayered laminate may be modified to change the properties of a product produced from the laminate, e.g., a shop towel.

In some embodiments, the temperature, bonding time and pressure of the process can be modified to allow for more efficient production of the laminate and to dial in various desirable properties. The technique of combining webs and optimizing product properties through thermal bonding is known to those skilled in the art of thermal bonding. However, the resulting laminate should demonstrate a minimum bond strength between the layers when tested using AATCC 136 test method.

After the nonwoven fabric layers have been combined through thermal bonding, the laminate web may optionally be ring rolled or micrexed to improve the drape of the towel. Equipment such as that manufactured by Biax Fiberfilm Corporation and by MICREX® Corporation may be used to improve the drapability of the towel. The ring rolling and micrexing processes are designed to reduce the stiffness of the composite towel laminate without introducing holes or excessively reducing the durability of the towel. Those trained in the arts of ring rolling and micrexing are knowledgeable about the many machine configurations and settings that can be used to achieve this objective. A multi-layered nonwoven laminate may be slit to the desired width as rolls of the laminate are wound up during the continuous process. These rolls may then be slit to the desired length to create towels (e.g. shop towels) and may optionally be folded and packaged.

Further provided is a method for manufacturing a multi-layered laminate as described herein. Thus, in some embodiments, a method of manufacturing a multi-layered laminate is provided, comprising: thermally laminating together a first outer nonwoven fabric layer, a second outer nonwoven fabric layer, and an inner nonwoven fabric layer that is between the first and second outer nonwoven fabric layers, wherein the first outer nonwoven fabric layer comprises thermoplastic fibers in an amount greater than 50% by weight (e.g., greater than 50, 55, 60, 65, 70, 75, 80, 85, 90, 95, 100% by weight) of the first outer nonwoven fabric layer and the second outer nonwoven fabric layer comprises thermoplastic fibers in an amount greater than 50% by weight (e.g., greater than 50, 55, 60, 65, 70, 75, 80, 85, 90, 95, 100% by weight) of the second outer nonwoven fabric layer; and wherein the multi-layered laminate does not comprise pores or comprises pores with an area of less than 0.03 square mm (e.g., less than 0.03, 0.029, 0.028, 0.027, 0.026, 0.025, 0.024, 0.023, 0.022, 0.021, 0.02, 0.019, 0.018, 0.017, 0.016, 0.015, 0.014, 0.013, 0.012, 0.011, 0.01, 0.009, 0.008, 0.007, 0.006, 0.005, 0.004, 0.003, 0.002, 0.0001 square millimeters, or any range or value therein). When present, an inner nonwoven fabric layer that is thermally laminated together with a first outer nonwoven fabric layer and a second outer nonwoven fabric layer may comprise thermoplastic fibers in an amount greater than 50% by weight (e.g., greater than 50, 55, 60, 65, 70, 75, 80, 85, 90, 95, 100% by weight) of the at least one inner nonwoven fabric layer.

In some embodiments, the laminating step may include thermally laminating a first outer nonwoven fabric layer, a second outer nonwoven fabric layer, and an inner nonwoven fabric layer that is between the first and second outer nonwoven fabric layers with appropriate settings of temperature, pressure, line speeds (i.e., dwell time). In some embodiments, the conditions used on the thermal-bonding laminator may be about 200° F. to about 450° F. on anvil and pattern bonding rolls, a pressure in a range of about 100 to about 800 pounds per linear inch (pli) between the bonding rolls and/or a line speed of about 50 to about 1000 feet per minute.

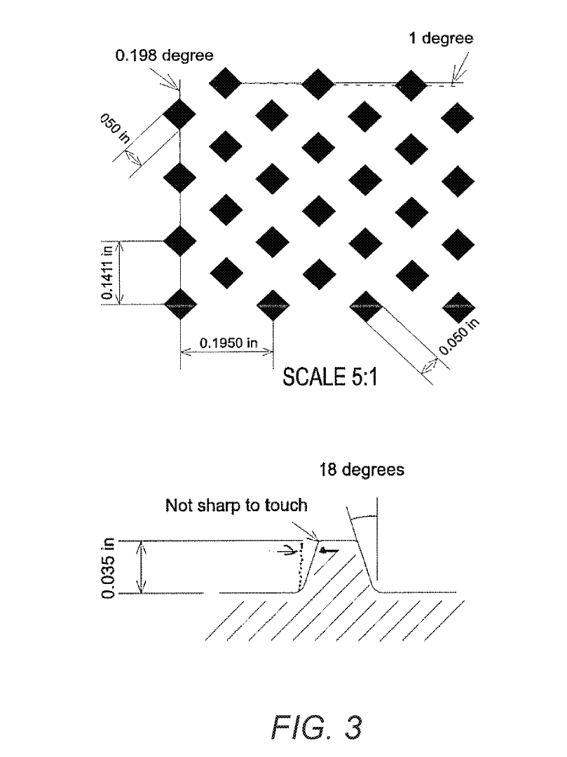

In some embodiments, a bond pattern is used, wherein the bond pattern comprises, consists essentially of, consists of a bonded area in a range of about 8% to about 25% (e.g., about 8, 9, 10, 11, 12, 13, 14, 15, 16, 17, 18, 19, 20, 21, 22, 23, 24, 25% or any range or value therein) of the laminate. In some embodiments, the bonded area is from about 10 to about 25%, about 15 to about 25%, about 10% to about 20%, about 15% to about 20%, and the like. A laminate bond pattern may provide a bond strength in the machine direction (MD) and/or cross direction (XD) in a range of about 20 grams/inch to about 500 grams/inch (e.g., about 20, 30, 40, 50, 60, 70, 80, 90, 100, 125, 150, 175, 200, 225, 250, 275, 300, 325, 350, 375, 400, 425, 450, 475, 500 grams/inch, or any range or value therein), optionally about 100 grams/inch to about 300 grams/inch (e.g., about 100, 110, 120, 130, 140, 150, 160, 170, 180, 190, 200, 210, 220, 230, 240, 250, 260, 270, 280, 290, 300 grams/inch, or any range or value therein), as determined in accordance with AATCC 136. In some embodiments, the bond pattern comprises, consists essentially of, consists of a bonded area in a range of about 10% to about 15% (e.g., about 10, 11, 12, 13, 14, 15%, or any range or value therein), which may achieve a laminate having a bond strength in the machine direction (MD) and/or cross direction (XD) in a range of about 20 grams/inch to about 500 grams/inch, optionally about 100 grams/inch to about 300 grams/inch, using method AATCC 136. In some embodiments, the bond pattern may comprise about 20 to about 60 bond points per square inch (e.g., about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60 bond points, or any range or value therein). In some embodiments, an exemplary bond pattern may be that provided in FIG. 3.

A nonwoven fabric layer that may be used in the manufacturing of a multi-layered laminate of the present invention may be mechanically treated and/or have undergone any suitable mechanical treatment, including, but not limited to, calendaring, creping, embossing, and/or stretching. In some embodiments, a nonwoven fabric layer that may be used in the manufacturing of a multi-layered laminate of the present invention may be and/or have been chemically treated for certain properties, such as, but not limited to, flame retardancy, antistatic, antimicrobial, corrosion inhibition, color, opacity, dimensional stability, coefficient of friction, softness, drapability and/or the like.

Many improvements and variations to the above embodiments are immediately evident to those trained in the art of nonwoven fabric manufacturing. For example, the blend of fibers in the nonwoven fabrics may be varied to achieve better economics and/or absorption properties. Additives of many types, such as, e.g., to impart color, hydrophilicity, antistatic properties, antioxidants, stabilizers, and/or absorbers may be added to the any of the components used to make a multi-layer laminate of the invention. Additional fiber types may be introduced into the webs to improve the stability of the multi-layered laminate of the preset invention and/or to change the esthetics and/or performance properties. Various polymers and/or fibers may be used to improve the thermal bonding properties of each layer. In some embodiments, more than three layers may be used to make a multi-layered laminate of the present invention. For example, a square mesh scrim comprised of polyester or glass fibers may be introduced into the laminate to improve the strength properties of the multi-layer laminate. Various bond patterns may be used to improve the aesthetic (handle and/or drape) and/or physical properties (strength and wash durability) of the multi-layered laminate. The materials used to make the multi-layered laminate may themselves be layered to impart a gradient to the fabric such as a hydrophilic vs. lipophilic gradient, a lofty vs. dense gradient or a scrubby vs. smooth gradient. Furthermore, the hand of a towel produced from the multi-layered laminate of the present invention may be modified through many techniques including, sanding, repeated washing, and/or micrexing.

The invention will now be described with reference to the following examples. It should be appreciated that these examples are not intended to limit the scope of the claims to the invention, but are rather intended to be exemplary of certain embodiments. Any variations in the exemplified methods that occur to the skilled artisan are intended to fall within the scope of the invention.

### EXAMPLES

### Example 1. Development of a Prototype Nonwoven Multi-Layer Laminate for Use as a Towel

A prototype three layer nonwoven laminate was developed using a high woodpulp content in the nonwoven fabric. The prototype contains a high proportion of cellulosic fiber throughout the three layers of the product.

The prototype comprises (a basis weight of 3.9 oz/yd²) 70% woodpulp (fiber diameter:about 0.2 to 100 microns; fiber length: about 5 to 3500 microns) and 30% polypropylene spunlaced web (denier: about 0.8 to 4 denier; fiber length: about 0.5 to 2 inches) using a thermal bonding calendar between two 28 gsm (grams per square meter) 80% polypropylene (fiber length 0.5 to 3 inches and denier is 0.6 to 5) 20% rayon (length about 0.5 to 2.5 inches and denier about 0.8 to 4) carded and thermally bonded webs. The bonding pattern used for preparing the prototype is shown in FIG. 3. The equipment was run at 50 feet per minute (fpm) with the anvil and pattern rolls both at 300 degrees Fahrenheit (° F.). The resulting prototype laminate fabric was cut and evaluated for absorbency and drape qualities, which were determined to be sufficient to merit further evaluation for use as a towel. The prototype towel sample had the dimensions of 12.5″ width by 13.5″ length.

The prototype towel samples were subsequently washed and dried in a commercial laundering process and the towels began to fall apart due to inadequate tie down of the cellulosic fibers and the thermal shrinkage of the polypropylene fibers. The lint released by the prototype towels was enough to block the lint screens on the commercial drier.

The towels were used in the market in the same fashion as regular cotton shop towels and then commercially laundered. The towels that could not be adequately cleaned by laundering and those that deteriorated during laundering were discarded prior to the next field use. The deterioration of the towels during the laundering process limited the evaluation process to four cycles of use and laundering. Not only did the towels deteriorate during laundering but they also lacked puncture resistance as demonstrated by the very low Mullen Burst (INDA 30.0-70) values obtained for these towels compared to the values obtained for the incumbent cotton towels.

### Example 2. Multi-Layer Laminate of the Invention and Exemplary Towel Produced Therefrom

Polypropylene-polyester sheath-core fibers were incorporated into the first and second outer nonwoven fabric layers with about 30% viscose fibers (rayon). Polypropylene sheath of the sheath core fibers provides a lower bonding temperature than polyester but is melt-stable at commercial dryer temperatures (e.g., about 400° F. to about 500° F.). Further, the polypropylene may provide resistance to detergents and chemicals that can be present in lipophilic soiling such as oil and grease. The polyester core can provide reduced shrinkage, and increased durability and strength to the outer layers. Without wishing to be bound by any particular theory, the incorporation of the sheath-core fibers may reduce the thermal shrinkage of the laminate, maintain the thermal bonding of the outer layers and/or provide strength. See, Table 2 comparing the shrinkage of the prototype towels with that of an example towel produced from the multi-layer laminate of the invention. In some embodiments, the shrinkage may be about 2% in MD and XD for a cotton towel. In some embodiments, a bonding pattern that may be used with the multilayer laminate of the invention may include, but is not limited to, that provided in FIG. 3.

The laminate appears to experience some thermal and mechanical shrinkage and deformation in both the commercial washing and drying processes. However, it appears that the greater deformation occurs in the dryer step. As shown in Table 2, some thermal shrinkage occurred but surprisingly, the deformation appears to affect the outer layers of the multi-layered laminate to a greater extent than the inner layer. While not wishing to be bound to any particular theory, this may be the result of the commercial drying process in which a towel dries from the outside and water is wicked away from the center layer and as the center layer gives up moisture it may impart a cooling effect on the inner layer of the laminate towel.

In this example, three fabric layers were thermally bonded to make a multi-layered nonwoven laminate, which was then ring rolled then cut to the appropriate size to be used as a towel (e.g., shop towel). The first outer nonwoven layer of the multi-layered laminate comprises 70% polypropylene-polyester sheath core bicomponent fibers (sheath 50% polypropylene; core 50% polyester) (denier: about 0.6 to 5; fiber length: about 0.5 to 3) carded with 30% rayon fibers (denier: about 0.8 to 4; fiber length: about 0.5 to 2.5) that was thermally bonded to create a 28 gsm web. The inner nonwoven layer of the multi-layered laminate is comprised of a spunbond polypropylene web containing a red colored pigment master batch incorporated during the spunbonding process (denier: about 0.6 to 3). The inclusion of the pigment master batch is an optional feature of the second layer. In this example, the second nonwoven layer of the multi-layered laminate is identical to the first outer nonwoven layer. The thermal bonding process was carried out on a Kusters steel on steel calendar where the anvil and pattern roll were heated to a temperature to allow the three webs to be bonded together.

The characteristics and functionality of towels produced using the multilayer laminate of the present invention were compared to towels produced using a prototype multi-layered laminate as described above in Example 1 and to standard cotton towels. The data are provided below in Tables 1-3, which show the advantages of a towel produced from the multi-layered laminate of the invention including strength, absorbency, efficiency of drying and cleaning, and durability.

TABLE 1
Comparison of the prototype nonwoven towel and standard cotton towel with
an example towel made from the multilayered laminate of the invention.

| | | | Multilayered | |
|---|---|---|---|---|
| | | | Laminate Towel | |
| | | First Prototype | Material | |
| | | (failed in wash | (present | Standard 100% |
| Description | | durability) | invention) | Cotton Towel |
| Physical Properties | | | | |
| Basis weight (grams/sq yd) ASTM D3776 | | 133 | 141 | 187 |
| Grab Tensile (lbs.) ASTM D5034 | MD | 30 | 50 | 44 |
| | XD | 20 | 42 | 25 |
| Caliper (inches) ASTM D1777 | | 0.029 | 0.036 | 0.029 |
| Handle-O-Meter (grams/inch) INDA 90.0-75 | MD | 77 | 128 | |
| (4″ × 7″, 20 mm gap) | XD | 28 | 55 | |
| Bond Strength (grams/inch) 2″pull, 180 degree | MD | 84 | 206 | |
| angle, 12 in/min pull rate. AATCC 136 | | | | |
| | XD | 74 | 173 | |
| Absorbency Rate (seconds) INDA 10.1 | | 4.8 | 9.3 | 30+ |
| Absorbent Capacity (%) | | 452 | 406 | 503 |
| Peel Strength/Bond Strength (grams) measured | MD | 231 | 853 | |
| as in U.S. Pat. No. 7,645,353 | | | | |
| | XD | 137 | 726 | |
| Pore Size (Porous Materials Automated | Mean pore size | 0.015 | 0.029 | 0.063 |
| Capillary Flow Porometer, Model CFP-1100- | in mm | | | |
| AEX using Galwick 15.9 Dynes/cm fluid | | | | |
| | | | Shalag 50 gsm | |
| | | | Thermal Bond, | |
| | | | 70% Sheath | |
| | | | Core | |
| | | | Bicomponent | |
| | | Shalag 28 gsm | Fiber (Sheath | |
| | | Thermal Bond, | 50% | |
| | | 80% | Polypropylene, | |
| Fabric Construction | | Polypropylene | Core 50% | |
| Outer Layers (first and second outer | | Fiber, 20% | Polyester), 30% | |
| nonwoven layers) | | Viscose Fiber | Viscose Fiber | |
| Viscose Fiber Component Properties | | | | |
| Fiber Length | inches | 0.5 to 2.5 | 0.5 to 2.5 | |
| Denier | denier | 0.8 to 4 | 0.8 to 4 | |
| Polypropylene Fiber Component Properties | | | | |
| Fiber Length | inches | 0.5 to 3 | | |
| Denier | denier | 0.6 to 5 | | |
| Sheath Core Bicomponent Fiber (Sheath 50% | | | | |
| Polypropylene, Core 50% Polyester) Component | | | | |
| Properties | | | | |
| Fiber Length | | | 0.5 to 3 | |
| Denier | | | 0.6 to 5 | |
| | | Suominen 78 gsm | | |
| | | Spinlaced Fabric, | | |
| | | 70% Woodpulp | | |
| | | Fibers, 30% | Mogul 40 gsm | |
| | | Polypropylene | spunbond | |
| Inner nonwoven layer | | Meltspun Fiber | Polypropylene | |
| Polypropylene Fiber Component Properties | | | | |
| Fiber Length | inches | 0.5 to 2 | continuous | |
| | | | (extruded) | |
| Denier | denier | 0.8 to 4 | 0.6 to 3 | |
| Woodpulp Fiber Component Properties | | | | |
| Fiber Length | microns | 5 to 3500 | not applicable | |
| Fiber Diameter | microns | 0.2 to 100 | | |
| | | | Kenmore Series 700 | Kenmore Series 700 |
| Moisture Evaporation Rate in Dryer - | | | Electric Dryer setting | Electric Dryer setting |
| 15 towels | | | medium | medium |

| | | time to dry (minutes) | |
|---|---|---|---|
| | | 10 minutes | 30 minutes |
| Dry weight (grams) | | 231 | 407 |
| Wet weight after wash and spin (grams) | | 314 | 641 |
| % water in towels | | 35.9 | 57.5 |
| Grams water removed drying per minute | | 8.3 | 7.8 |
| Soil Release | Not Tested | 98% Removed | 50% removed |
| Durability | Delamination of towel | No delamination or | Frayed edges after 5 |
| | after one wash and dry | linting after 8 washes | washes and dry |
| | cycle | and dry cycle | |

*large holes caused by thermal bond points

TABLE 2
Comparison of the thermal shrinkage for prototype towel and an
example towel manufactured from the multi-layer laminate of
the invention.

| | | | Thermal |
|---|---|---|---|
| | | | Shrinkage |
| | | | 325 F. for 5 |
| Substrate | Composition | | minutes |
| Composite towel outer | 28 gsm 80/20 PP/Viscose | MD | 8% |
| layers | Rayon | | |
| | | XD | 0% |
| Composite towel outer | 50 gsm 70/30 PP/PET | MD | 0% |
| layers | Bico + Viscose Rayon | | |
| | | XD | 0% |
| Log Book 364, page 69 | | | |

TABLE 3
Comparison of the dynamic wiping efficiency of a standard cotton towel and an
example towel produced from the multi-layer laminate of the invention. Dynamic wiping
efficiency was determined in accordance with ASTM D6702-1.

| | | | A | | B | | C |
|---|---|---|---|---|---|---|---|
| | | | Avg. | Stdev. | Avg. | Stdev. | Pick- |
| | | | Initial | Initial | Liquid | Liquid | Up (% |
| | Liquid | | Weight | Weight | sorbed | sorbed | Wt of |
| Sample ID | Used | Laundered | (grams) | (grams) | (grams) | (grams) | Towel) |
| PFG Laminate | Water | PFG (5X) | 7.83 | 0.08 | 6.27 | 0.42 | 80% |
| Towel | | | | | | | |
| PFG Laminate | Motor oil | PFG (5X) | 7.75 | 0.14 | 6.38 | 0.02 | 82% |
| Towel | | | | | | | |
| 100% Cotton | Water | PFG (5X) | 11.19 | 0.64 | 9.46 | 0.36 | 85% |
| Towel | | | | | | | |
| 100% Cotton | Motor oil | PFG (5X) | 11.04 | 1.45 | 7.32 | 0.42 | 66% |
| Towel | | | | | | | |

Notes:
Sample size is 9″ × 9″
Volume of challenge liquid is 10 mls.
Avg. of five repetitions for each data point.
Liquid Sorbed (C) calculated by B divided by A
Liquid Sorbed (C) calculated is grams of water per gram weight of towel

The foregoing is illustrative of the present invention, and is not to be construed as limiting thereof. The invention is defined by the following claims, with equivalents of the claims to be included therein.

That which is claimed is:

1. A multi-layered laminate comprising:
a first outer nonwoven fabric layer comprising thermoplastic fibers in an amount greater than 50% by weight of the first outer nonwoven fabric layer;
a second outer nonwoven fabric layer comprising thermoplastic fibers in an amount greater than 50% by weight of the second outer nonwoven fabric layer; and
an inner nonwoven fabric layer that is between the first and second outer nonwoven fabric layers,
wherein the multi-layered laminate does not comprise pores or comprises pores with an area of less than 0.03 square millimeters.

2. The multi-layered laminate of claim 1, wherein first outer nonwoven fabric layer, the second outer nonwoven fabric layer, and the inner nonwoven fabric layer are thermally bonded together.

3. The multi-layered laminate of claim 1, wherein the thermoplastic fibers of the first outer nonwoven fabric layer and/or the second outer nonwoven fabric layer comprise a length of about 0.5 to about 3 inches and/or a denier of about 0.6 to about 5.

4. The multi-layered laminate of claim 1, wherein the first outer nonwoven fabric layer further comprises absorbent fibers in an amount of less than 50% by weight of the first outer nonwoven fabric layer and/or the second outer nonwoven fabric layer further comprises absorbent fibers in an amount of less than 50% by weight of the second outer nonwoven fabric layer.

5. The multi-layered laminate of claim 4, wherein the absorbent fibers are cellulosic fibers.

6. The multi-layered laminate of claim 1, wherein the thermoplastic fibers of the first outer nonwoven fabric layer and/or the second outer nonwoven fabric layer comprise a fiber with a polypropylene sheath and a polyester core.

7. The multi-layered laminate of claim 1, wherein the thermoplastic fibers of the first outer nonwoven fabric layer, the second outer nonwoven fabric layer, and/or the inner nonwoven fabric layer have a melting point above 220° F., a thermal shrinkage less than about 5% at 220° F., and/or can be thermally bonded.

8. The multi-layered laminate claim 1, wherein the thermoplastic fibers of the first outer nonwoven fabric layer, and/or the second outer nonwoven fabric layer comprises polypropylene fibers, polyester fibers, polyethylene terephthalate fibers, polylactic acid fibers, polyolefin fibers, and/or blends thereof.

9. The multi-layered laminate of claim 1, wherein the first outer nonwoven fabric layer, the second outer nonwoven fabric layer, and/or the inner nonwoven fabric layer comprise a blend of thermoplastic fibers and absorbent fibers.

10. The multi-layered laminate of claim 1, wherein the first outer nonwoven fabric layer, the second outer nonwoven fabric layer, and/or the inner nonwoven fabric layer comprise a spunlaced blend of absorbent fibers and sheath-core polypropylene (PP)/polyester (PET) fibers.

11. The multi-layered laminate of claim 1, wherein the first outer nonwoven fabric layer, the second outer nonwoven fabric layer, and/or the inner nonwoven fabric layer comprise at least about 70% sheath-core PP/PET fibers and about 30% or less absorbent fibers.

12. The multi-layered laminate of claim 11, wherein the absorbent fibers are rayon fibers.

13. The multi-layered laminate of claim 11, wherein the sheath-core PP/PET fibers have a ratio of PP to PET of about 50% to 50%.

14. The multi-layered laminate of claim 9, wherein the thermoplastic fibers of the inner nonwoven fabric layer comprise a denier of about 0.6 to about 5.

15. The multi-layered laminate of claim 1, wherein the multi-layered laminate has a thermal shrinkage of less than 5% when heated to 325° F. for five minutes.

16. The multi-layered laminate of claim 1, wherein the multi-layered laminate comprises about 20 to about 60 bond points per square inch.

17. The multi-layered laminate of claim 1, wherein the first and/or second outer nonwoven fabric layers and/or the inner nonwoven fabric layer have a basis weight in a range of about 15 grams per square meter (gsm) to about 70 gsm, optionally about 45 gsm to about 55 gsm.

18. The multi-layered laminate of claim 1, wherein the multi-layered laminate comprises a bonded area in a range of about 10% to about 20%.

19. The multi-layered laminate of claim 1, wherein the multi-layered laminate has a grab tensile strength in the machine direction (MD) in a range of about 25 lbs to about 60 lbs, optionally about 40 lbs to about 50 lbs using method ASTM D5034, and/or a grab tensile strength in the cross-machine direction (XD) of about 15 lbs to about 60 lbs, optionally about 30 lbs to about 40 lbs, using method ASTM D5034.

20. The multi-layered laminate of claim 1, wherein the multi-layered laminate has a laminated bond strength in the machine direction (MD) and cross direction (XD) in a range of about 20 grams/inch to about 500 grams/inch, optionally about 100 grams/inch to about 300 grams/inch, using method AATCC 136

21. The multi-layered laminate of claim 1, wherein the multi-layered laminate has a Mullen Burst strength of at least about 20 psi with a range of about 20 psi to about 120 psi.

22. The multi-layered laminate of claim 1, wherein the multi-layered laminate has a Handle-O-Meter value in the MD in a range of about 90 grams/inch to about 160 grams/inch, optionally about 110 grams/inch to 140 grams/inch using test method IVDA 90.0-75 with 20 mm gap on instrument and a 4 inch (width) by 7 inch (length) sample of the laminate and/or a Handle-O-Meter value in the XD in a range of about 20 grams/inch to about 80 grams/inch, optionally about 35 grams/inch to about 65 grams/inch using test method IVDA 90.0-75 with 20 mm gap on instrument and a 4 inch (width) by 7 inch (length) sample of the laminate.

23. The multi-layered laminate of claim 1, wherein the multi-layered laminate has an Elmendorf tear strength in the MD and/or in the XD of at least about 2000 grams with a range of about 1000 grams to about 3000 grams.

24. The multi-layered laminate of claim 1, wherein the multi-layered laminate has a fluid absorbance capacity of at least about 500% as measured using method IVDA 10.1.

25. A towel comprising the multi-layered laminate of claim 1, optionally wherein the towel is a shop towel.

26. A method of manufacturing a multi-layered laminate, the method comprising:
thermally laminating together a first outer nonwoven fabric layer, a second outer nonwoven fabric layer, and an inner nonwoven fabric layer that is between the first and second outer nonwoven fabric layers,
wherein the first outer nonwoven fabric layer comprises thermoplastic fibers in an amount greater than 50% by weight of the first outer nonwoven fabric layer and the second outer nonwoven fabric layer comprises thermoplastic fibers in an amount greater than 50% by weight of the second outer nonwoven fabric layer; and
wherein the multi-layered laminate does not comprise pores or comprises pores with an area of less than 0.03 square mm.
